(19) United States
(12) Patent Application Publication
(10) Pub. No.: US 2003/0163732 A1
(43) Pub. Date: Aug. 28, 2003

(54) Device-specific firewall

(76) Inventor: Travis J. Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/086,746

(22) Filed: Feb. 28, 2002

(51) Int. Cl. G06F 11/30

(52) U.S. Cl. 713/201; 713/154

(57) ABSTRACT

A device-specific filtering method includes receiving a packet from a network, evaluating the packet to determine whether or not it or a file thereof has one or more undesirable characteristics and/or desirable characteristics, and controlling further transmittal and/or processing of one or more files of the packet based upon such evaluation. The device-specific filtering method may be effected by a destination device, such as a printer, for the transmitted packet or by a computer associated with a destination device. Programs, apparatus, and systems that effect the filtering method are also disclosed.

### BACKGROUND OF THE INVENTION

1. Field of the Invention

The present invention relates generally to methods and apparatus for providing security to printers and, more specifically, to filtering programs, which are also referred to as “firewalls,” for preventing files with certain characteristics from being printed.

2. Background of Related Art

Typically, when a computer sends a file to a printer of a network (e.g., a local area network (LAN)), the file, including information about a location where the file is stored, the length of the file, and the type of file, is one part of a so-called “packet” that is transmitted to the printer. In addition, the packet will include information about the source of the file (i.e., the computer from which the file originated). The packet will also identify the designated printer to which the file and the packet of which it is a part are being transmitted, as well as other information relating to how the file is to be printed.

The server of a LAN may be configured to limit the access of certain workstations or users to specific devices of the LAN. For example, accessibility to a certain printer could be limited to the users that are members of a specific group. Nonetheless, the inventor is not aware of any programming for LAN servers that limits the types of files that may pass from a workstation of the LAN to a printer of the LAN.

When unprintable files, such as executable files (e.g., files that include the extension “.exe”), driver files (e.g., files with extensions such as “.dll,” “.drv,” etc.), configuration files (e.g., files having “.cfg” extensions), audio files, video files, and the like, are sent to a network printer, these unprintable files may occupy positions in the queue for that printer, preventing subsequently sent files from being printed until an authorized user or network administrator discovers the problem and clears the print queue.

In addition, it may not be desirable to permit the transmission of various types of files, including some files that are attached to e-mails or that are transmitted to a workstation of a LAN via the Internet, to other devices on the LAN, such as printers thereof. In particular, computer viruses that target the electronic components of printers, such as processors and memory thereof, are becoming more predominant and increasingly dangerous.

Due to device usage concerns, such as device workload at certain times of the day or by overwhelming a device's queue with a large number of files to be processed, it may also be desirable to limit the transmittal of files to a device or processing of files by the device.

It is not uncommon for some network users to abuse the use of a particular file destination device (e.g., a printer) or a collection of destination devices of a network. Accordingly, it may be desirable to limit the number or cumulative sizes of files transmitted by a particular user or from a particular workstation to a specific destination device. Alternatively, it may be desirable to limit the total number of files that may be transmitted from a particular workstation or network user over a specified period of time.

While filtering programs, or firewalls, are widely used to prevent unwanted guests from accessing computers and networks, as well as for preventing undesirable file types from finding their way to various network devices and specified users from accessing certain network devices, the inventor is not aware of any device-specific filtering programs, or firewalls, for limiting access to particular devices on a network, such as the printers thereof.

Accordingly, there is a need for a method and apparatus by which packets that include files to be printed may be evaluated, or “screened,” prior to being printed and, based on such screening, for preventing the files of packets with at least one predetermined, undesirable characteristic from being printed.

### SUMMARY OF THE INVENTION

The present invention includes filtering undesirable packets that include files to be printed by evaluating, or “screening,” the characteristics of each packet that includes a file to be printed and, based upon such screening, identifying packets having at least one prespecified, undesirable characteristic. This filtering may prevent the files of packets that are determined to have at least one prespecified, undesirable characteristic from being printed. Alternatively, the filtering may permit printing of the files of packets that have at least one prespecified, desirable characteristic.

In one aspect, the present invention includes a filtering method. A packet that is sent to a printer is evaluated to determine one or more of the various characteristics thereof, including, without limitation, the type of each file included in the packet, particular strings of files (e.g., those strings which may be found in common computer viruses), the identity of the computer from which the print command was initiated, the size of each file in the packet, and the time of day during which the packet is being sent. One or more of the identified characteristics may then be evaluated. In one variation of the method, files that have one or more characteristics that have been determined to be undesirable are prevented from being printed. In another variation, the method includes allowing the files of packets that have characteristics that have been determined to be desirable to be printed. When multiple packet characteristics are considered, some combination of these variations may be used to determine whether or not the file of a packet may or may not be printed.

In another aspect, the present invention includes a filtering program, or so-called “firewall”. The filtering program may be embodied as software stored by a memory device or upon memory media (e.g., a floppy disk, a compact disk read-only memory (CD-ROM), a hard disk, etc.), firmware, or programmed hardware, and may be executed by the processor of a printer or by the processor of a computer, such as a server, associated with the printer.

Other aspects of the invention include devices and systems that are associated with networks and with which a filtering program according to the present invention may be used. An exemplary embodiment of such a device or system is a printer or printing system. A printing system incorporating teachings of the present invention includes a printer and the filtering program. Among other things, the printer includes a processor and a printing component. A file to be printed is transmitted as part of a packet by a source external to the printer. Upon receipt of a packet by the processor, the filtering program causes the processor to evaluate certain, prespecified characteristics of the packet. If the packet lacks undesirable characteristics and/or has one or more desirable characteristics, the processor further evaluates the packet, which, in addition to the file to be printed, may include instructions pertinent to printing of the file (e.g., information on the source of sheets of paper or other media onto which printing is to be effected, information about the orientation in which the file is to be printed upon the sheets, information about whether printing is to be effected on one or both sides of the sheets, the number of copies to be printed, whether or not multiple printed copies of the file are to be collated, etc.), and controls operation of the printing component, which prints the file onto one or more sheets of paper or other media.

In addition to a printer and a filtering program, another embodiment of printing system according to the present invention includes an external computer, such as a device-specific or dedicated server or a network server, in communication with the processor of the printer. The filtering program is executed by a processor of the external computer rather than by the processor of the printer. Accordingly, a packet that includes a file to be printed is evaluated by the computer processor, under control of the filtering program, for one or more undesirable characteristics and/or one or more desirable characteristics. Upon approval by the filtering program, the packet is transmitted to the processor of the printer. Once the printer processor receives the packet, other information carried as the processor of the printer may evaluate part of the packet and the processor may cause the printing component of the printer to print a visible version of the file onto one or more sheets of paper or other media.

Other features and advantages of the present invention will become apparent to one of ordinary skill in the art through consideration of the ensuing description, the accompanying drawings, and the appended claims.

### BRIEF DESCRIPTION OF THE DRAWINGS

In the drawings, which depict exemplary embodiments of various aspects of the present invention:

FIG. 1 is a flow chart depicting an exemplary filtering process incorporating teachings of the present invention;

FIG. 2 is a schematic representation of the method depicted in the flow chart of FIG. 1;

FIG. 3 is a flow chart that depicts a first method for evaluating one or more of the characteristics of a packet that includes a file to be printed;

FIG. 4 is a flow chart that depicts a second method for evaluating one or more of the characteristics of a packet that includes a file to be printed;

FIG. 5 is a flow chart that depicts a third method for evaluating one or more of the characteristics of a packet that includes a file to be printed;

FIG. 6 is a schematic representation of a first embodiment of a printing system according to the present invention; and

FIG. 7 is a schematic representation of a second embodiment of a printing system according to the present invention.

### DETAILED DESCRIPTION

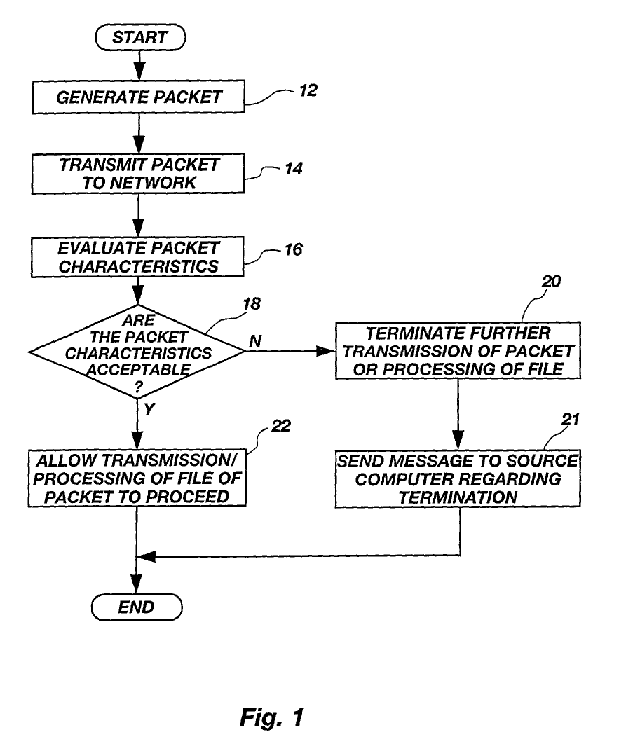

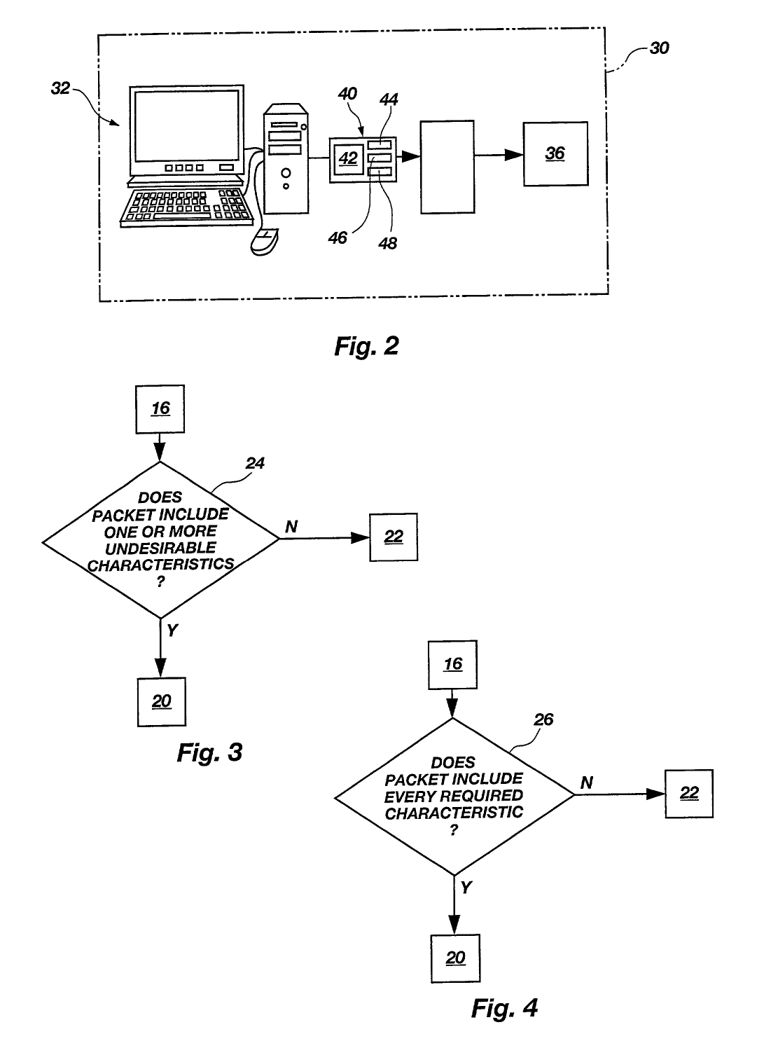

With reference to drawing FIGS. 1 and 2, one aspect of the present invention includes a method for filtering files that are being transmitted across a network 30 from a source computer 32 to another device 36 of network 30. The process flow of an exemplary embodiment of a filtering method according to the present invention is depicted in the flow chart of drawing FIG. 1 and the schematic representation of drawing FIG. 2. At reference character 12 of drawing FIG. 1, a packet 40 is generated by a source computer 32, or workstation, of a network 30 with instructions that packet 40 be sent to another device 36 of network 30, such as a printer.

Packet 40 includes at least one transmitted file 42, as well as identifiers 44, 46 for both source computer 32 and device 36. In addition, packet 40 may include information 48 about any action to be taken with respect to each transmitted file 42 thereof. By way of example only, when device 36 to which packet 40 is to be transmitted comprises a printer and packet 40 includes a file 42 that is to be printed thereby, information 48 may include instructions for the printer that relate to one or more of the following: the source of sheets of paper or other media onto which printing is to be effected; information about the orientation in which file 42 is to be printed upon the sheets; information about whether printing is to be effected on one or both sides of the sheets; the number of copies to be printed, whether or not multiple printed copies of the file are to be collated; or the like.

Next, at reference character 14 of drawing FIG. 1, packet 40 is output by source computer 32 onto network 30 for transmittal to device 36. At reference character 16 of drawing FIG. 1, which occurs “upstream” of any further processing or use of a file 42 of packet 40 or before packet 40 reaches its final destination, i.e., device 36, one or more characteristics of packet 40 are evaluated. These evaluated characteristics may be one or more undesirable characteristics, one or more desirable, or required, characteristics, or some combination thereof.

Turning now to the flow chart of drawing FIG. 3, packet 40 (FIG. 2) may be evaluated for one or more undesirable characteristics at reference character 24. Examples of undesirable characteristics that packet 40 may include and which may be subject to evaluation include, without limitation, certain file types (e.g., file types that cannot be printed, such as files having .exe, .dll, .cfg, or .vbs extensions, audio files, video files, etc.), a file that includes a particular string (e.g., a string that is unique to one or more computer viruses or device-specific viruses), an identifier for a prespecified source computer 32, an identifier for a prespecified user, a file size that exceeds a maximum threshold, a time-consuming command for device 36 (e.g., a command that a large number of copies be made, a complex print command, etc.), the time at which packet 40 is being transmitted, or the like. If packet 40 does include one or more undesirable characteristics, process flows to reference character 20 of drawing FIG. 1, where further transmission or processing of packet 40 or a file 42 thereof is terminated. Otherwise (i.e., if packet 40 lacks any of the prespecified, undesirable characteristics), process flows to reference character 22 of drawing FIG. 1.

As an alternative to the process depicted in drawing FIG. 3, the process at reference character 18 of drawing FIG. 1 may include an evaluation of whether or not packet 40 has one or more desired, or required, characteristics, as shown in drawing FIG. 4. Examples of desired, or required, characteristics may include, but are not limited to, an identifier for source computer 32 that corresponds to an identifier of a prespecified set of source computers, an identifier for a user that corresponds to an identifier of a prespecified set of users, a password, a prespecified file type, as indicated by an extension of the name of file 42, or the like. At reference character 26 of drawing FIG. 4, a determination is made as to whether or not packet 40 includes every prespecified, desired characteristic that is required for packet 40 to be transmitted to device 36 or for device 36 to process a file 42 of packet 40. For packets 40 that do not include every desired, or required, characteristic, process flows to reference character 20 of drawing FIG. 1. If, in the alternative, packet 40 includes every prespecified, desired characteristic, process flows to reference character 22 of drawing FIG. 1.

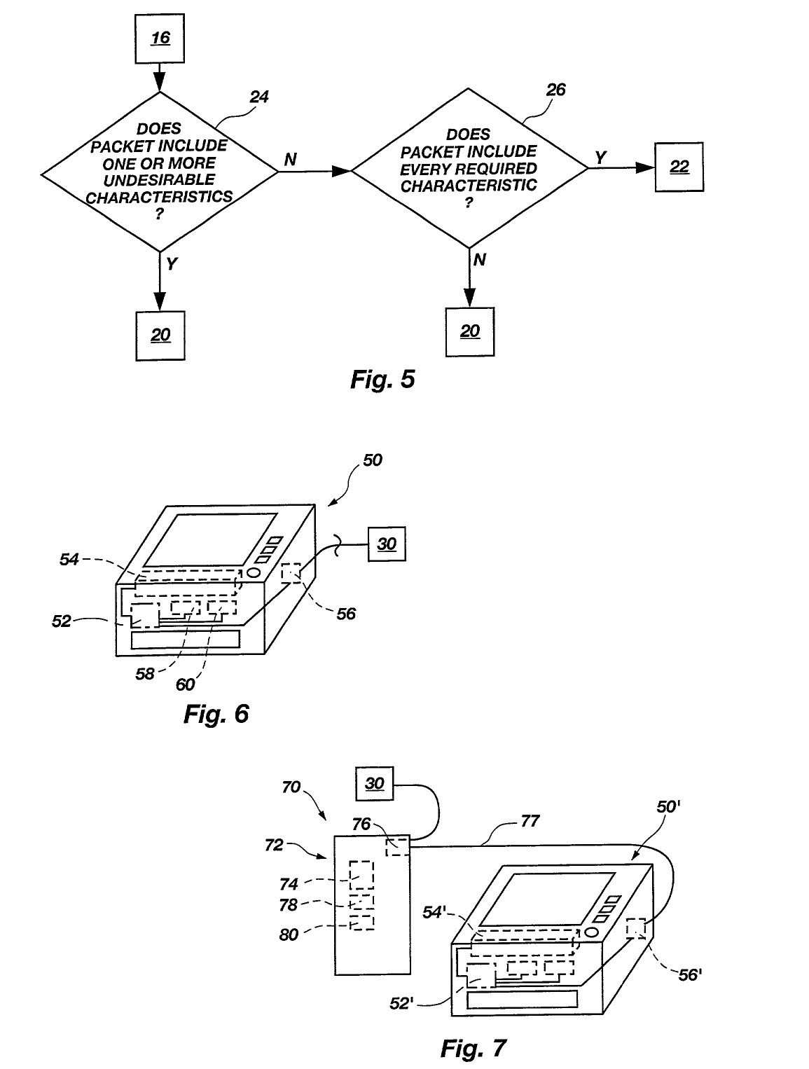

As another alternative of the process that may be effected at reference character 18 of drawing FIG. 1, each packet 40 may be evaluated for both desirable and undesirable characteristics. An exemplary process flow of this alternative is illustrated in drawing FIG. 5. At reference character 24 of drawing FIG. 5, a packet 40 (FIG. 2) is evaluated to determine whether or not it has any undesirable characteristics. If so, process flows to reference character 20 of drawing FIG. 1. If packet 40 is free of any undesirable characteristics, process proceeds to reference character 26 of drawing FIG. 5, where a determination is made as to whether or not packet 40 has every desirable, or required, characteristic that has been prespecified. If not, process flows to reference character 20 of drawing FIG. 1. In the event a packet 40 lacks any of the prespecified, undesirable characteristics and has each of the prespecified desired, or required, characteristics, process flows to reference character 22 of drawing FIG. 1.

If process returns from drawing FIG. 3, 4, or 5 to reference character 20 of drawing FIG. 1, further transmission of packet 40 is terminated or device 36 is instructed not to perform the desired activity on one or more files 42 of packet 40. In either event, packet 40 may be prevented from further residing in any component of device 36.

Optionally, at reference character 21 of drawing FIG. 1, a message may be generated and sent to source computer 32, informing the user thereof that the desired transmission or action was terminated. Such a message may include information about why transmission and/or processing of packet 40 or one or more files 42 thereof was terminated, which, of course, may correspond to each undesirable characteristic of packet 40 or to each desired, or required, characteristic that packet 40 lacks.

If, in the alternative, process returns from drawing FIG. 3, 4, or 5 to reference character 22 of drawing FIG. 1, packet 40 is transmitted to device 36 and any desired processes (e.g., printing) may be conducted on one or more files 42 of packet 40.

The present invention also includes a program or group of programs by which a method incorporating teachings of the present invention may be effected. Such programs may be embodied as software and, thus, maintained on one or more storage media, such as a hard drive, a floppy disk, CD-ROM, random-access memory (RAM), or the like. Alternatively, programs according to the present invention may be in the form of firmware or programmed or programmable hardware.

Such a program may, of course, be written in a programming language that will be understood by each processor with which the program is to be used. A program according to the present invention may be embodied as software, which is maintained on a storage device associated with a processor and which may be accessed by that processor, as firmware or as programmed hardware. Each of these embodiments of programs, as well as the manner in which each of these types of programs may be generated and used, are well known in the art.

Schematically, depicted in drawing FIG. 6 is a printer 50 that incorporates teachings of the present invention. Printer 50 includes a processor 52 and a printing component 54 in communication with and under control of processor 52. In addition, printer 50 includes a communication port 56 that communicates with processor 52 in such a way as to establish communication between processor 52 and devices external to printer 50, such as a server and various other devices of network 30 (FIG. 2). Printer 50 may also include one or more memory devices 58, such as RAM, a hard drive, a disk drive (e.g., a floppy disk drive, a CD-ROM drive, a tape drive, etc.), or the like. Alternatively, or in addition, printer 50 may include firmware 60.

A filtering program that is configured to cause processor 52 of printer 50 to effect a filtering method in accordance with the present invention may be stored by a memory device 58 or firmware 60 of printer 50. Processor 52 is configured to execute such a filtering program upon receiving a packet 40 (FIG. 2) from network 30 (FIG. 2) through communication port 56. If packet 40 meets the requirements of the filtering program (i.e., lacks any undesirable characteristics and/or has each desired, or required, characteristic), processor 52 may cause one or more files 42 of packet 40 to be printed by printing component 54 of printer 50.

Another exemplary embodiment of printing system 70 according to the present invention is depicted in drawing FIG. 7. Printing system 70 includes a printer 50′ and a server 72. Printer 50′ includes a processor 52′ and a printing component 54′ that is in communication with processor 52′ and that is configured to effect the printing of files onto sheets of media, such as paper. A communication port 56′ of printer 50′ is also in communication with processor 52′ and facilitates the transmittal of signals, such as packets 40 (FIG. 2), between processor 52′ and external devices, such as those of network 30 (FIG. 2).

Server 72 may comprise a central network server or be dedicated for use with printer 50′. In either event, server 72 acts as a “gateway” through which packets 40 must pass before being transmitted to printer 50′. Server 72 of printing system 70 includes a processor 74 and a communication port 76 that facilitates communication between other devices (e.g., source computer 32 (FIG. 2) of network 30 (FIG. 2) and processor 74, as well as communication between processor 74 and processor 52′ of printer 50′. In addition, server 72 may include one or more memory devices 78, such as RAM, a disk drive, a hard drive, or the like, that communicate with processor 74. Alternatively, or in addition to the one or more memory devices 78, server 72 may include firmware 80.

A memory device 78 or firmware 80 of server 72 may store a filtering program according to the present invention. Upon receiving a packet 40 (FIG. 2) from network 30 (FIG. 2), processor 74 of server 72, under control of the filtering program, evaluates packet 40 and determines whether or not packet 40 will be transmitted to printer 50′. If packet 40 meets the requirements of the filtering program (i.e., lacks any undesirable characteristics and/or has each desired, or required, characteristic), processor 74 sends packet 40 through communication port 76, along a connection 77 between communication port 76 of server 72 and communication port 56′ of printer 50′, and into processor 52′ of printer 50′. Packet 40 may be temporarily stored by a memory device 58′ associated with printer 50′. Processor 52′ may then cause printing component 54′ to print one or more files 42 (FIG. 2) of packet 40.

Although the foregoing description contains many specifics, these should not be construed as limiting the scope of the present invention, but merely as providing illustrations of some exemplary embodiments. Similarly, other embodiments of the invention may be devised which do not depart from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A printing system, comprising:
a printer including:
a processor; and
a printing component in communication with said processor; and
a filtering program associated with said processor so as to control printing of a file by said printing component based on at least one of a presence or absence of at least one prespecified characteristic from a packet including said file.

2. The printing system of claim 1, wherein said filtering program is stored by at least one of a memory device and firmware of said printer associated with said processor.

3. The printing system of claim 1, wherein said filtering program is stored by at least one of a memory device and firmware external to said printer and in communication with said processor.

4. The printing system of claim 3, further comprising:
a computer including said at least one of said memory device and said firmware, a processor in communication with said at least one of said memory device and said firmware, and a communication port for at least partially establishing communication between said processor of said computer and said processor of said printer.

5. The printing system of claim 1, wherein said at least one prespecified characteristic comprises at least one of an undesirable characteristic and a desirable characteristic.

6. The printing system of claim 5, wherein said filtering program causes said processor to prevent said printing component from printing a file of a packet having at least one said undesirable characteristic.

7. The printing system of claim 5, wherein said filtering program instructs said processor to cause said printing component to print a file of a packet having said desirable characteristic.

8. The printing system of claim 5, wherein said filtering program instructs said processor to cause said printing component to print said file only if said packet lacks said undesirable characteristic and has said desirable characteristic.

9. The printing system of claim 5, wherein said undesirable characteristic comprises one of a file type, a file string, a source computer identifier, a user identifier, a file size, and at least one prespecified command.

10. The printing system of claim 5, wherein said desirable characteristic comprises one of a source computer identifier, a user identifier, a file type, and a password.

11. A device-specific filtering method, comprising:
transmitting a packet comprising at least one file from a source computer, across a network, to a device of said network;
evaluating at least one prespecified characteristic of said packet following passage of said packet through a server of said network; and
controlling at least one of further transmission of said packet to said device and processing of said at least one file of said packet by said device based on said evaluating.

12. The device-specific filtering method of claim 11, wherein said evaluating at least one prespecified characteristic comprises evaluating at least one of an undesirable characteristic and a desirable characteristic.

13. The device-specific filtering method of claim 12, wherein said controlling comprises preventing said at least one of further transmission of said packet to said device and processing of said at least one file of said packet by said device if said packet has at least one said undesirable characteristic.

14. The device-specific filtering method of claim 12, wherein said controlling comprises permitting said at least one of further transmission of said packet to said device and processing of said at least one file of said packet by said device if said packet has said desirable characteristic.

15. The device-specific filtering method of claim 12, wherein said controlling comprises permitting said at least one of further transmission of said packet to said device and processing of said at least one file of said packet by said device if said packet lacks said undesirable characteristic and has said desirable characteristic.

16. The device-specific filtering method of claim 12, wherein said evaluating comprises evaluating said packet for at least one said undesirable characteristic comprising at least one of a file type, a file string, a source computer identifier, a user identifier, a file size, and at least one prespecified command.

17. The device-specific filtering method of claim 12, wherein said evaluating comprises evaluating said packet for at least one said desirable characteristic comprising at least one of a source computer identifier, a user identifier, a file type, and a password.

18. The device-specific filtering method of claim 11, wherein said evaluating is effected by a processor of said device.

19. The device-specific filtering method of claim 11, wherein said evaluating is effected by a processor external to and in communication with a processor of said device.

20. A system for filtering a file transmitted to a destination device, comprising:
a processor in communication with a network across which the file has been transmitted; and
a filtering program associated with said processor so as to control at least one of transmission of a packet including at least one file to the destination device and processing of said at least one file by the destination device based on at least one of a presence or absence of at least one prespecified characteristic from said packet including said at least one file.

21. The system of claim 20, wherein said filtering program is stored by at least one of a memory device and firmware.

22. The system of claim 21, wherein said processor and said memory device or said firmware are parts of the destination device.

23. The system of claim 21, wherein said processor and said memory device or said firmware are parts of a computer in communication with the destination device.
